(19) United States
(12) Patent Application Publication
(10) Pub. No.: US 2010/0264752 A1
(43) Pub. Date: Oct. 21, 2010

(54) POWER SUPPLY CONTROL SOCKET

(75) Inventors: Kwok Fong WONG, Tsuen Wan N.T. (HK); Pui Yi CHING, Tsuen Wan N.T. (HK)

Correspondence Address: SUGHRUE MION, PLLC, 2100 PENNSYLVANIA AVENUE, N.W., SUITE 800, WASHINGTON, DC, 20037, US

(73) Assignee: SHINING UNION LIMITED, Tsuen Wan N.T. (HK)

(21) Appl. No.: 12/759,380

(22) Filed: Apr. 13, 2010

(30) Foreign Application Priority Data
Apr. 17, 2009 (HK) 09103586.5

(51) Int. Cl. H02J 4/00; G06F 7/04

(52) U.S. Cl. 307/116; 340/5.83; 307/113

(57) ABSTRACT

A power supply control socket comprises a casing, socket apertures, a power supply control device including a fingerprint scanning unit, a fingerprint matching unit and a control unit connected together in series and a micro switch. The fingerprint scanning unit collects and transmits fingerprint information of users to the fingerprint matching unit. The fingerprint matching unit compares the fingerprint information to fingerprint templates pre-stored in the power supply control device. The control unit controls power supply according to comparison results. The micro switch is provided behind the socket apertures for closing a circuit when a plug is inserted to the socket apertures to enable the control of the control unit. The invention controls power supply to the socket by means of fingerprint authentication and the micro switch, which could greatly improve electrical safety. Thus, it is not necessary to worry about leakage of electricity even when children touch the socket.

### CROSS-REFERENCE TO RELATED APPLICATIONS

The application claims the priority benefits of Hong Kong Short-Term Patent Application No. 09103586.5 filed on Apr. 17, 2009, the contents of which are hereby incorporated by reference in its entirety.

### FIELD OF THE INVENTION

The present invention generally relates to the field of electricity control, and more particularly relates to a power supply control socket controlled by means of fingerprint authentication.

### DESCRIPTION OF THE RELATED ART

Currently, there are many household electrical appliances and power supply sockets within doors, and electrical safety is extensively concerned. Most of the household electrical appliances are supplied with 220V alternating current, which is not a safe voltage. In addition, some of the electrical appliances, such as televisions, may generate over 10000V high voltage. If getting an electric shock by touching such a high voltage, people would be in danger of losing their lives. Even worse, sockets generally supply alternating current of 220V directly.

The traditional household electrical appliances and power supply sockets ensure the electrical safety by means of various mechanical measures mainly comprising:
1. Electricity parts of the electrical appliances and sockets are usually sealed by provided with insulating members, to protect users against electric shock. If the insulating members are damaged, the protection could only depend on ambient environment, such as traditional pendant pull switches.
2. The electrical appliances and sockets are provided with a grounding terminal, such as three-phase sockets.
3. Conductive parts of the electrical appliances and sockets which are easy to be accessed are connected to protective conductors provided within a fixed wiring, which could prevent the conductive parts from becoming charged bodies even if the insulating members are invalid.
4. The protection against electric shock could also be achieved by only supplying power of safe low voltage generated from isolation transformers.

In addition, more and more household electrical appliances are not only unsafe for children, but also could affect children physiologically and psychologically. Therefore, if necessary, parents should limit their children access to those household electrical appliances, such as televisions, computers, etc.

However, in reality, the present inventors also find out the following faults in the prior art.

Firstly, regardless of the protective measures against electric shock, there is still a risk to some extent, such as the invalidation of insulating members or isolation transformers.

Secondly, some kinds of household electrical appliances could prevent access of children by setting passwords, such as computers. However, the passwords are easy to be disclosed, and most of the household electrical appliances even could not be set and protected by passwords. Therefore, the effect of limiting the access of children is not satisfied.

### SUMMARY OF THE INVENTION

To overcome the above-mentioned faults, the present invention aims to provide a power supply control socket which could solve the problems on potential safety risks and lower the difficulties in limiting the access of children to some electrical appliances in the prior art.

According to one aspect of the present invention, there is provided a power supply control socket comprising a casing, socket apertures, a power supply control device and a micro switch, in which the power supply control device comprises a fingerprint scanning unit, a fingerprint matching unit and a control unit connected together in series, and a fingerprint scanning section of the fingerprint scanning unit is provided on the casing; the fingerprint scanning unit is used to collecting fingerprint information of users, and transmit the fingerprint information to the fingerprint matching unit; the fingerprint matching unit is used to compare the fingerprint information collected by the fingerprint scanning unit to fingerprint templates pre-stored in the power supply control device to identify the users; the control unit is used to control the power supply according to fingerprint comparison results; the micro switch is provided behind the socket apertures, and is used to close a circuit when a plug is inserted to the socket apertures to enable the control unit to control the power supply according to the fingerprint comparison results.

Preferably, the power supply control socket of the present invention may further comprise a dual-inline package switch composed of a plurality of on-off switches, in which the dual-inline package switch is provided on the casing and covered by a sealing cover, and is used to manually control the power supply in emergency.

Preferably, the power supply control socket of the present invention may further comprise a communication unit which is used to communicate with communication units of other power supply control sockets to transmit fingerprint information to the other power supply control sockets.

Preferably, the control unit of the present invention may further comprise a programmable dual-inline package switch which is used to pre-set ON/OFF states of several power supply control devices within a certain range.

Preferably, the control unit of the present invention may further comprise a power control module for controlling output power of the power supply control socket according to different fingerprint information.

Preferably, the power supply control device may further comprise an alarming unit for indicating scanning states and results of the fingerprint scanning unit.

As mentioned above, the power supply control socket of the present embodiment controls power supply to the socket by means of fingerprint authentication, which could not only effectively limit the access of children to the electrical appliances, but also keep the electrical appliances or sockets in an off state even if the fingerprint authentication device is invalid. Therefore, the electrical safety could be improved. Furthermore, the electrical safety of the power supply control socket of the present embodiment could be further improved by means of the micro switch, thus it is not necessary to worry about leakage of electricity even when children touch the socket.

### BRIEF DESCRIPTION OF THE DRAWINGS

Specific embodiments of the power supply control socket disclosed in the present application will now be described by way of example with reference to the accompanying drawings, wherein:

FIG. 1 is a front view of a power supply control socket according to a first embodiment of the present invention;

FIG. 2 is a schematic view of a power supply control device according to the first embodiment of the present invention;

FIGS. 3a and 3b illustrate a circuit diagram of the configuration of the power supply control device according to the first embodiment of the present invention;

FIG. 4 is an enlarged schematic view of the part A in FIG. 3b;

FIG. 5 is a cross-sectional view taken along the line A-A in FIG. 1 according the first embodiment of the present invention; and

FIG. 6 is a schematic view of the configuration of a power supply control device according to a second embodiment of the present invention.

### DESCRIPTION OF PREFERRED EMBODIMENTS

The aspects, features and advantages of the present invention will be better understood by those skilled in the art from the detailed description of the embodiments of the invention in conjunction with the accompanying drawings. Exemplary embodiments of the present application and the description thereof are for illustration purpose only, and should not be construed as limitation to the protective scope of the present invention.

### First Embodiment

FIG. 1 illustrates a front view of the power supply control socket according to the first embodiment of the present invention. The power supply control socket comprises a casing 101, socket apertures 102, a fingerprint scanning section 103, a dual-inline package (DIP) switch 104, a sealing cover 105, a LED indicating lamp 108 and a speaker 109. The socket apertures 102, fingerprint scanning section 103, DIP switch 104, LED indicating lamp 108 and speaker 109 are all provided on the casing 101, in which the DIP switch 104, sealing cover 105, LED indicating lamp 108 and speaker 109 are optional.

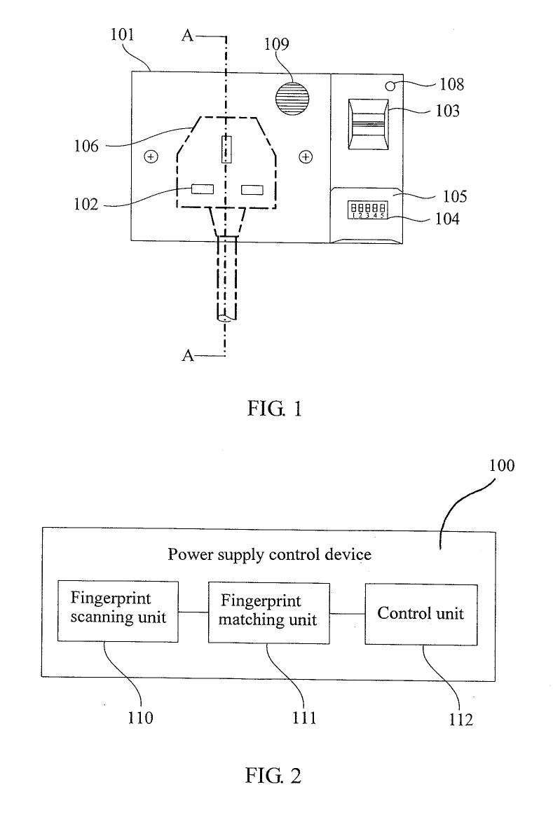

The above only illustrates the outside configuration of the power supply control socket of the first embodiment of the present invention, which may further comprise a power supply control device. The power supply control device comprises a fingerprint scanning unit 110, a fingerprint matching unit 111 and a control unit 112 connected together in series (as shown in FIG. 2). In an embodiment, the power supply control device could be integrated into a circuit board.

The fingerprint scanning unit 110 is used to collect fingerprint information of users and send the collected fingerprint information to the fingerprint matching unit 111. In fact, the fingerprint scanning unit 110 is a fingerprint sensor. The fingerprint information of users collected by the fingerprint scanning unit 110 is an analog signal initially, which could be converted to a digital signal by an analog-to-digital converter (ADC) module provided within the fingerprint scanning unit 110 and then be transmitted to the fingerprint matching unit 111 to be matched therein. Fingerprint sensors generally comprise single-touch sensors and sweep sensors. However, the present embodiment does not limit the type of the fingerprint sensor for collecting fingerprint information.

Several pieces of registered digital fingerprint information are pre-stored in the fingerprint matching unit 111. The pre-stored fingerprint information is authorized fingerprint information, while the other fingerprint information is illegal and could not pass fingerprint authentication. Upon receipt of the digital fingerprint information from the fingerprint scanning unit 110, the fingerprint matching unit 111 compares the digital fingerprint information to the pre-stored fingerprint information, and then transmit the comparison result to the control unit 112, in which the comparison could be realized by means of a variety of algorithms.

The control unit 112 is connected to the fingerprint matching unit 111 and a power source respectively for controlling power supply to the present power supply control socket according to the judgment of the fingerprint matching unit 111. If a user passes the fingerprint authorization, the power supply control device would supply power to the socket. Otherwise, the socket would not be supplied with power.

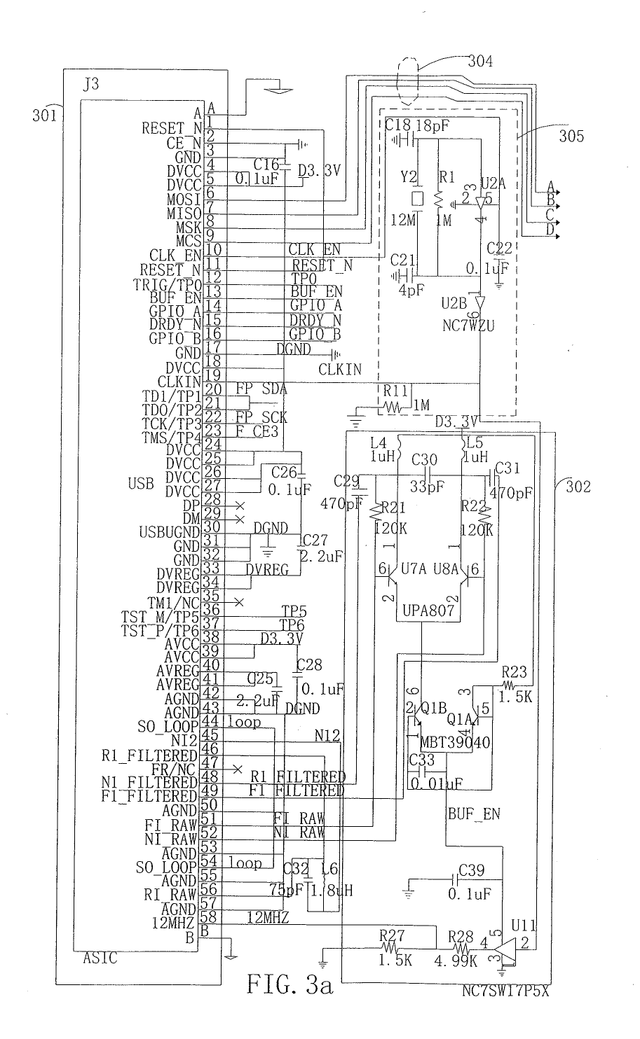

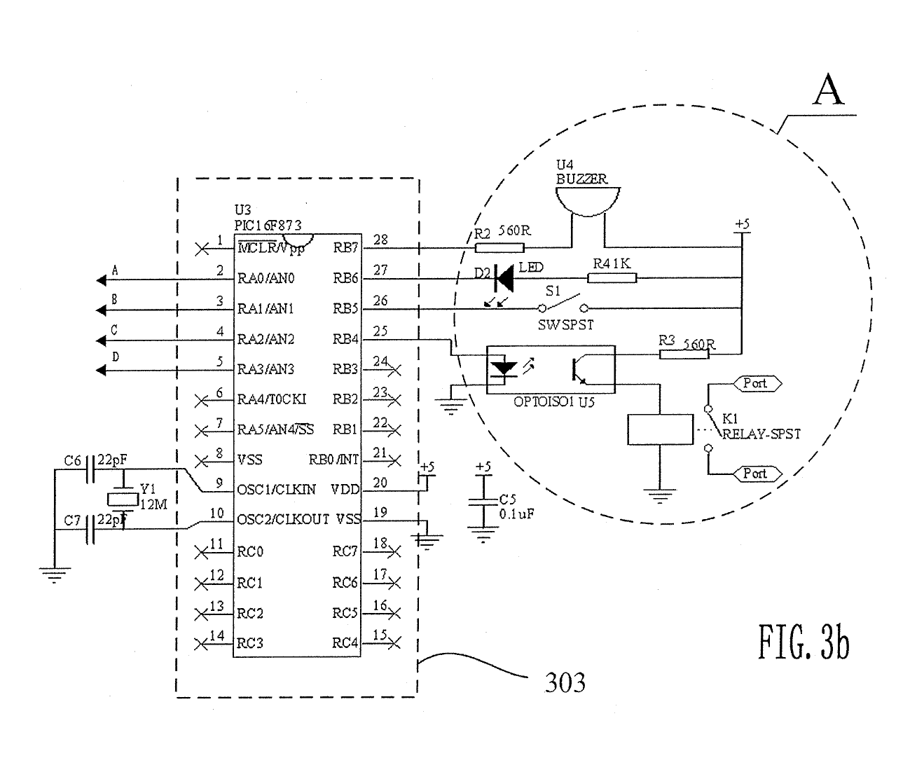

The above-mentioned inner units of the power supply control device 100 are divided logically. However, it is possible that some units could also be integrated into a single device. FIGS. 3a and 3b illustrate a circuit diagram of the power supply control device according to the first embodiment of the present invention. As shown in the figure, the circuit diagram comprises an integrated circuit chip 301 acting as a fingerprint sensor, an analog-to-digital converter (ADC) circuit 302, a microprocessor chip 303 and an oscillation circuit 305.

The integrated circuit chip 301 receives fingerprint information collected by the upstream fingerprint collecting means, and filters out noise from the received fingerprint information. Then, the filtered fingerprint information is transmitted to the ADC circuit 302 through pins 48 and 49, to be converted there. Thus, the integrated circuit chip 301 and the ADC circuit 302 constitute the above-mentioned fingerprint scanning unit 110.

Pins 6, 7, 8 and 9 of the integrated circuit chip 301 are connected to pins 2, 3, 4 and 5 of the microprocessor chip 303 respectively by means of four conductive leads, and the integrated circuit chip 301 transmits the converted fingerprint information data to the microprocessor chip 303 through the lead set 304.

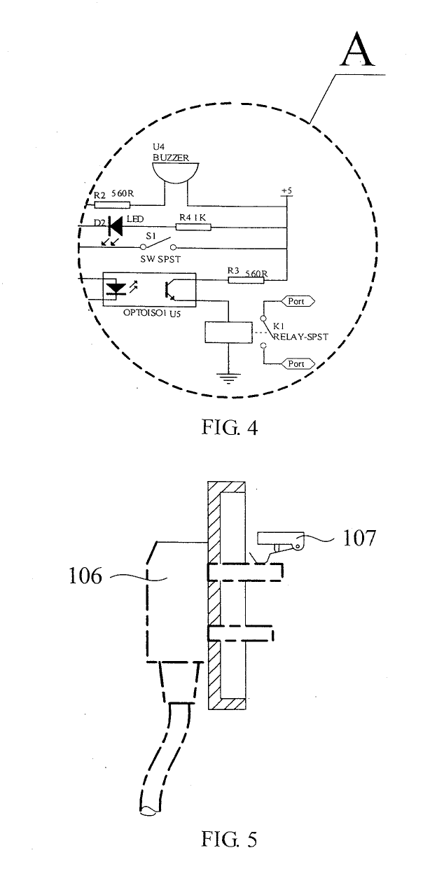

In the present embodiment, the microprocessor chip 303 is mainly used to perform two operations, i.e. fingerprint matching and power supply controlling. Obviously, the microprocessor chip 303 has already integrated the above fingerprint matching unit 111 and the control unit 112 into a single module. Fingerprint matching is a complex operation, but there are many algorithms for fingerprint matching in prior art. Therefore, the microprocessor chip 303 could employ a certain algorithm, and what the microprocessor chip 303 should do is only to perform such algorithm for fingerprint matching. Thus, the details of the internal operation of the microprocessor chip 303 will not described herein. The microprocessor chip 303 performs power supply control to the respective electrical appliances or sockets in turn according to the result of fingerprint matching. In the present embodiment, the power supply control is realized in the following manner. As shown in FIG. 4, which is an enlarged schematic view of the part A in FIG. 3b, a pin 25 of the microprocessor chip 303 is connected to an input end of an opto-isolator OPTOISO1 U5, while an output end of the opto-isolator OPTOISO1 U5 is connected to a relay. The opto-isolator OPTOISO1 U5 could perform electricity-light-electricity conversion, and therefore could control the current variation at its output end according to the current variation at its input end. The relay is also an electronic control device, and could control the on/off state of the output circuit when the input, such as current, voltage, temperature, etc. reaches predetermined value. In the present embodiment, the microprocessor chip 303 controls the on/off state of the output circuit of the relay by means of the output current of the pin 25. When the output circuit is closed, power supply lines are connected to the input end of the electrical appliances, and when the output circuit is opened, the power supply lines is disconnected to the input end of the electrical appliances. Thus, the object to control power supply to the electrical appliances or sockets could be achieved finally. It should be understood that if users could not pass the fingerprint authentication, the output circuit of the relay would be closed, and the electrical appliances or sockets would not be supplied with power.

The oscillation circuit 305 is well known in field of fingerprint sensor, which is mainly used to generate an internal clock signal for the fingerprint sensor. The details of the oscillation circuit will not be described herein.

As shown in FIG. 2, to realize control function of the microprocessor chip 303, a direct voltage of +5V should be supplied to the output end of the opto-isolator OPTOISO1 U5 at the right side. In the present embodiment, the direct voltage is generated by the 220V alternating current within the socket. In details, the voltage of 220V alternating current could be reduced by coils, and then be converted to direct current to output direct voltage of +5V. Although the +5V direct voltage could also be generated by batteries in the present embodiment, it would be more convenient for the users to generate the +5V direct voltage with the alternating current within the sockets directly since most of the electrical appliances are supplied with power by the sockets.

FIG. 5 is a cross-sectional view of the first embodiment of the present invention taken along the line A-A in FIG. 1. The power supply control socket of the present embodiment may further comprise a micro switch 107. The micro switch includes a base, a plate and an elastic contact. The plate is connected to the base at one end, and could rotate around a connection point therebetween. The elastic contact is mounted on the base, and is located within an included angle between the base and the plate. When a plug 106 is not inserted into the power supply control socket, the plate does not contact the elastic contact. At this time, even a user is determined as an authorized user through fingerprint scanning, the power supply control socket would not supply power yet. In another word, the socket is in an absolutely safe state now. After the plug 106 is inserted into the socket, the plate of the micro switch is pushed towards the elastic contact by conductive plug pins of the plug, and then contacts the elastic contact. At this time, the power supply control socket would still not supply power until the user passes the fingerprint authentication.

In addition, the fingerprint scanning section 103 is a part of the fingerprint scanning unit, which is used to collect fingerprint information. The DIP switch 104 is used to manually control power supply in emergency, for example, during the invalidation of the fingerprint scanning unit. As power supply could be controlled by the DIP switch, the sealing cover 105 is provided to prevent the DIP switch 104 of the present embodiment from being accessed by children. The sealing cover 105 could be opened by means of special tools, such as screwdrivers. The LED indicating lamp 108 is used to indicate status of fingerprint scanning. For example, when scanning is not performed, the LED indicating lamp 108 is in an off state. When scanning is performed, the LED indicating lamp is turned on. The speaker 109 is used to indicate scanning results of the fingerprint scanning, which explains various scanning results by means of various voice prompts.

As mentioned above, the power supply control socket of the present embodiment controls power supply to the electrical appliance or sockets by means of fingerprint authentication, which could not only effectively limit the access of children to the electrical appliances, but also keep the electrical appliances or sockets in an off state even if the fingerprint authentication device is invalid. Therefore, the electrical safety could be improved. Furthermore, the electrical safety of the power supply control socket of the present embodiment could be further improved by means of the micro switch, thus it is not necessary to worry about leakage of electricity even when children touch the socket.

### Second Embodiment

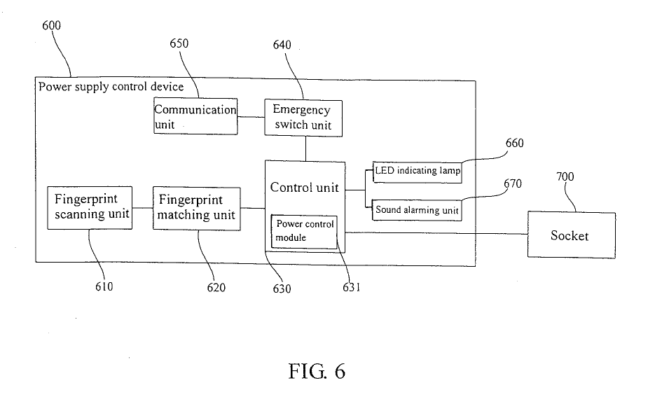

FIG. 6 is a schematic view of the configuration of the power supply control device according to the second embodiment of the present invention. The power supply control device 600 comprises a fingerprint scanning unit 601, a fingerprint matching unit 620 and a control unit 630, which could realize basic function of fingerprint scanning, matching and power supply control. The operation of the second embodiment is similar to that of the first embodiment, thus details of which will not be described herein.

In addition, as shown in FIG. 6, the electrical control device 600 may further comprise an emergency switch unit 640. The emergency switch unit 640 is connected to a socket 700, and could act as a fault emergency system. In another word, when power supply control device 600 could not control power supply due to a malfunction in the fingerprint scanning unit 610, the fingerprint matching unit 620 or the control unit 630, the power supply could be controlled manually by actuating the emergency switch unit 640. The emergency switch unit 640 may be comprised of a plurality of on-off switches. As an example, a DIP switch is comprised of 5 on-off switches, and each on-off switch has two states, i.e. “ON” and “OFF”. Users could define a state of the DIP switch for supplying power to the socket 700, such as, 1 ON, 2 ON, 3 OFF, 4 OFF, 5 ON. When users set the 5 on-off switches into the above-mentioned state accordingly, the socket 700 could be supplied with power.

As shown in FIG. 4, the power supply control device 600 of the present embodiment may further comprise a communication unit 650 for communicating with other power supply control devices within a network composed of a plurality of power supply control devices. The communication unit 650 could be a wireless communication device, such as a RF transceiver or an infrared transceiver. In particular, the communication among the respective power supply control devices is mainly in the following manner. Either of the power supply control devices sends fingerprint information signal to other power supply control devices by means of its communication unit 650, to control the power supply. As an example, a network is composed of 6 power supply control devices which are numbered as Nos. 1-6 in order. With respect to user A, the states pre-set for the devices Nos. 1, 3 and 5 are “ON”, i.e. being supplied with power, while the states pre-set for the devices Nos. 2, 4 and 6 are “OFF”, i.e. not being supplied with power. When users pass fingerprint authentication of either power supply control device, the power supply control device will automatically communicate with the other 5 power supply control devices in the network through its communication unit 650. The communication signal comprises the fingerprint information of the user A, which could command the other 5 power supply control devices in the network to control their respective power supply according to their respective pre-set states.

As shown in FIG. 4, the communication unit 650 of the present embodiment is also connected to the emergency switch unit 640. Thus, according to different fingerprints of different users, the states of individual power supply control devices in the network could be pre-set independently by means of the emergency switch unit 640. The emergency switch unit 640 could be a programmable DIP switch, which could be defined a state as being in programmable status. The above-mentioned DIP switch with 5 on-off switches could also be used as an example. For instance, if the state of the DIP switch is 1 OFF, 2 ON, 3 OFF, 4 OFF, 5 ON, the power supply control device 600 is in a programmable status.

The power supply control device of the present embodiment communicates with the other power supply control devices in the network through wireless communication devices. However, it is also possible that the respective power supply control devices communicate with each other through wired devices.

As shown in FIG. 4, the control unit 630 of the present embodiment may further comprise a power control module 631, which could control output power of various electrical appliances according to different fingerprint information. In reality, we do not need some electrical appliances to work under full-power state, such as some lighting apparatus. In this case, the present embodiment may pre-store different fingerprint information of the user, and control the power of the electrical appliances by the power supply control device 600 according to the pre-stored fingerprint information. For instance, a right thumb fingerprint of a user corresponds to 100% output power, a fingerprint of the user's right index finger corresponds to 80% output power, a fingerprint of the user's right middle finger corresponds to 60% output power, while a fingerprint of the user's fourth finger corresponds to 40% output power, etc.

The power supply control device 600 of the present embodiment may further comprise an alarming unit. The alarming unit may be a LED indicating lamp, a sound alarming unit, or their combination. As shown in FIG. 4, the power supply control device 600 of the present embodiment may further comprise a LED indicating lamp 660 and a sound alarming unit 670, in which the LED indicating lamp 660 is connected to the control unit 630 for indicating the status of the fingerprint scanning unit 610. For example, when scanning is not performed, the LED indicating lamp 660 is in an OFF state. When scanning is performed, the LED indicating lamp is turned on. The details of the configuration of the LED indicating lamp is similar to that of the LED D2 shown in FIG. 4. In addition, the sound alarming unit 670 is also connected to the control unit 630 for indicating the scanning results of the fingerprint scanning unit 610. The sound alarming unit 670 may be a buzzer or a speaker, which could generate different sounds to indicate whether the user is an authorized user. The details of the configuration of the sound alarming unit is similar to that of the buzzer U4 shown in FIG. 4. Of course, the present embodiment may choose either of the LED indicating lamp 660 and the sound alarming unit 670 to indicate both the status and scanning results of the fingerprint scanning unit 610 at the same time. In this case, the LED indicating lamp could emit lights of different colors, the speaker could send different voice signals, while the buzzer could generate different sounds. Thus, when an unregistered child tries to perform fingerprint scanning, the power supply control device 600 of the present embodiment would send out a warning.

As mentioned above, besides the advantages of the first embodiment of the present invention, the power supply control socket of the present embodiment with the above power supply control device has the following additional advantages. The emergency switch unit ensures the operation of the present embodiment even when some components are damaged, while the communication module improves the flexibility and convenience of the present embodiment. Furthermore, the power control module could reduce unnecessary energy consumption and lower costs.

Although some embodiments of the present invention have been shown and described with reference to the accompanying drawings, those skilled in the art should understand that various changes and modifications can be made to the embodiments without departing the principles and spirits of the present invention and they still fall into the scope of claims and the equivalent thereof.

What is claimed is:

1. A power supply control socket comprising a casing, socket apertures, a power supply control device and a micro switch, wherein the power supply control device comprises a fingerprint scanning unit, a fingerprint matching unit and a control unit connected together in series, and a fingerprint scanning section of the fingerprint scanning unit is provided on the casing, and the fingerprint scanning unit;
the fingerprint scanning unit is used to collecting fingerprint information of users, and transmit the fingerprint information to the fingerprint matching unit;
the fingerprint matching unit is used to compare the fingerprint information collected by the fingerprint scanning unit to fingerprint templates pre-stored in the power supply control device to identify the users;
the control unit is used to control power supply according to fingerprint comparison results;
the micro switch is provided behind the socket apertures, and is used to close a circuit when a plug is inserted to the socket apertures to enable the control unit to control power supply according to the fingerprint comparison results.

2. The power supply control socket according to claim 1 further comprising a dual-inline package switch composed of a plurality of on-off switches, wherein the dual-inline package switch is provided on the casing and covered by a sealing cover, and is used to manually control the power supply in emergency.

3. The power supply control socket according to claim 1 further comprising a communication unit which is used to communicate with communication units of other power supply control sockets to transmit fingerprint information to the other power supply control sockets.

4. The power supply control socket according to claim 3, wherein the control unit further comprises a programmable dual-inline package switch which is used to pre-set ON/OFF states of several power supply control devices within a certain range.

5. The power supply control socket according to claim 1, wherein the control unit further comprises a power control module for controlling output power of the power supply control socket according to different fingerprint information.

6. The power supply control socket according to claim 1, wherein the power supply control device further comprises an alarming unit for indicating scanning states and results of the fingerprint scanning unit.
